(19) United States
(12) Patent Application Publication
(10) Pub. No.: US 2023/0083706 A1
(43) Pub. Date: Mar. 16, 2023

(54) COMMUNICATION MANAGEMENT APPARATUS AND METHOD

(71) Applicants: KABUSHIKI KAISHA TOSHIBA, Minato-ku, Tokyo (JP); TOSHIBA DIGITAL SOLUTIONS CORPORATION, Kawasaki-shi, Kanagawa (JP)

(72) Inventors: Atsushi KAKEMURA, Kokubunji Tokyo (JP); Hideki TSUTSUI, Kawasaki Kanagawa (JP)

(73) Assignees: KABUSHIKI KAISHA TOSHIBA, Minato-ku, Tokyo (JP); TOSHIBA DIGITAL SOLUTIONS CORPORATION, Kawasaki-shi, Kanagawa (JP)

(21) Appl. No.: 17/800,437

(22) PCT Filed: Feb. 17, 2021
(86) PCT No.: PCT/JP2021/005839

§ 371 Date: Aug. 17, 2022

(30) Foreign Application Priority Data
Feb. 28, 2020 (JP) 2020-033828

(51) Int. Cl. G10L 15/22; G10L 25/60; H04M 3/42

(52) U.S. Cl. CPC G10L 15/22; G10L 25/60; H04M 3/42221

(57) ABSTRACT

A communication system includes a communication control section including a first control section configured to broadcast utterance voice data received from one of mobile communication terminals to other mobile communication terminals and a second control section configured to chronologically accumulate a result of utterance voice recognition from voice recognition processing on the received utterance voice data as a user-to-user communication history and to control text delivery such that the communication history is displayed on the mobile communication terminals in synchronization; and a utterance voice evaluation section configured to perform voice quality evaluation processing on the received utterance voice data and to output a result of voice quality evaluation. The communication control section is configured to control text delivery such that the result of voice recognition based on the utterance voice and the result of voice quality evaluation are displayed on the user terminals.

### TECHNICAL FIELD

Embodiments of the present invention relate to a technique for assisting in communication using voice and text (for sharing of recognition, conveyance of intention and the like).

### BACKGROUND ART

Communication by voice is performed, for example, with transceivers. A transceiver is a wireless device having both a transmission function and a reception function for radio waves and allowing a user to talk with a plurality of users (to perform unidirectional or bidirectional information transmission). The transceivers can find applications, for example, in construction sites, event venues, and facilities such as hotels and inns. The transceiver can also be used in radio-dispatched taxis, as another example.

### Prior Art Documents

### Patent Documents

[Patent Document 1] Japanese Patent Laid-Open No. 2000-155600

[Patent Document 2] Japanese Patent No. 4678773

### DISCLOSURE OF THE INVENTION

### Problems to be Solved by the Invention

It is an object of the present invention to achieve an environment in which the result of evaluation of ease of hearing of a user’s utterance voice is shared within a communication group, thereby assisting in quality improvement of information transmission among a plurality of users.

### Means for Solving the Problems

According to an embodiment, in a communication system, a plurality of users carry their respective mobile communication terminals, and the voice of an utterance of one of the users input to his mobile communication terminal is broadcast to the mobile communication terminals of the other users. The communication system includes a communication control section having a first control section configured to broadcast utterance voice data received from one of the mobile communication terminals to the other mobile communication terminals and a second control section configured to chronologically accumulate the result of utterance voice recognition from voice recognition processing on the received utterance voice data as a user-to-user communication history and to control text delivery such that the communication history is displayed on the mobile communication terminals in synchronization; and an utterance voice evaluation section configured to perform voice quality evaluation processing on the received utterance voice data and to output the result of voice quality evaluation. The communication control section is configured to control text delivery such that the result of voice recognition based on the utterance voice and the result of voice quality evaluation are displayed on the user terminals.

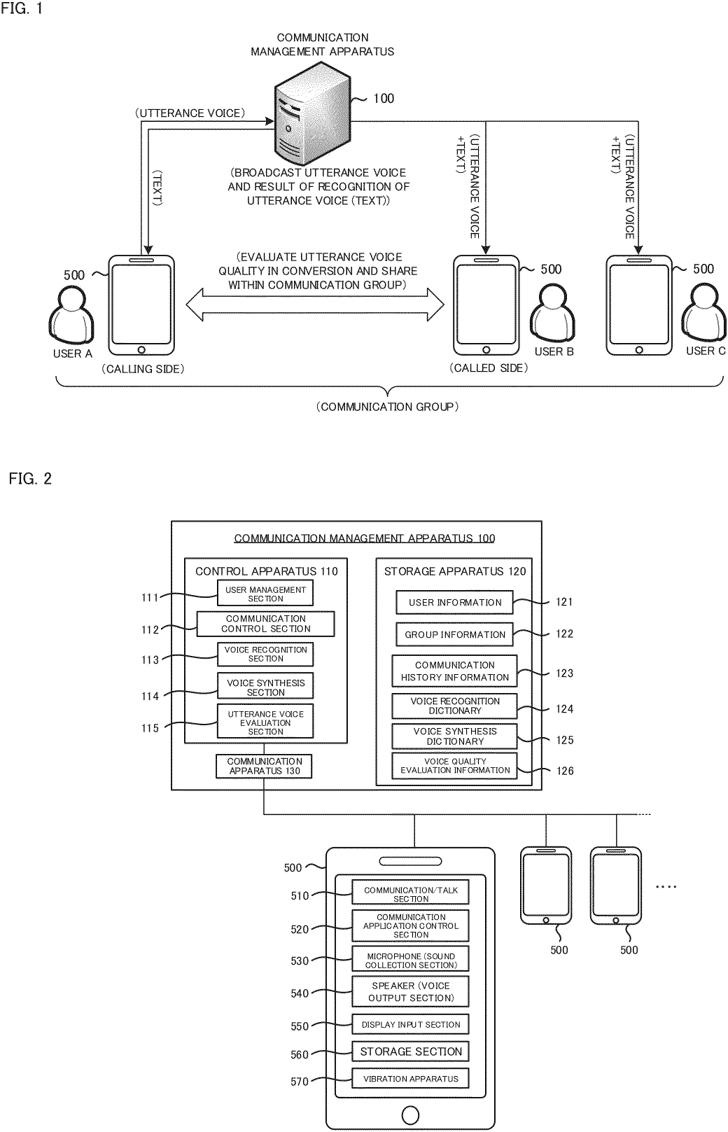

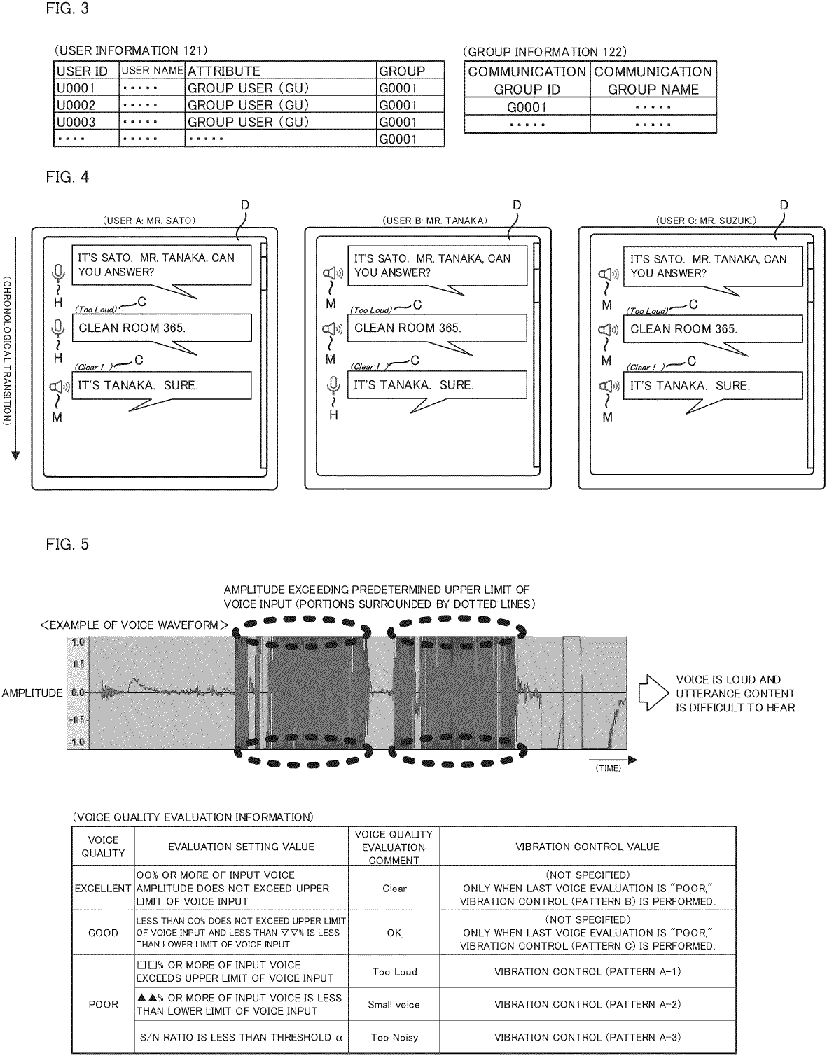

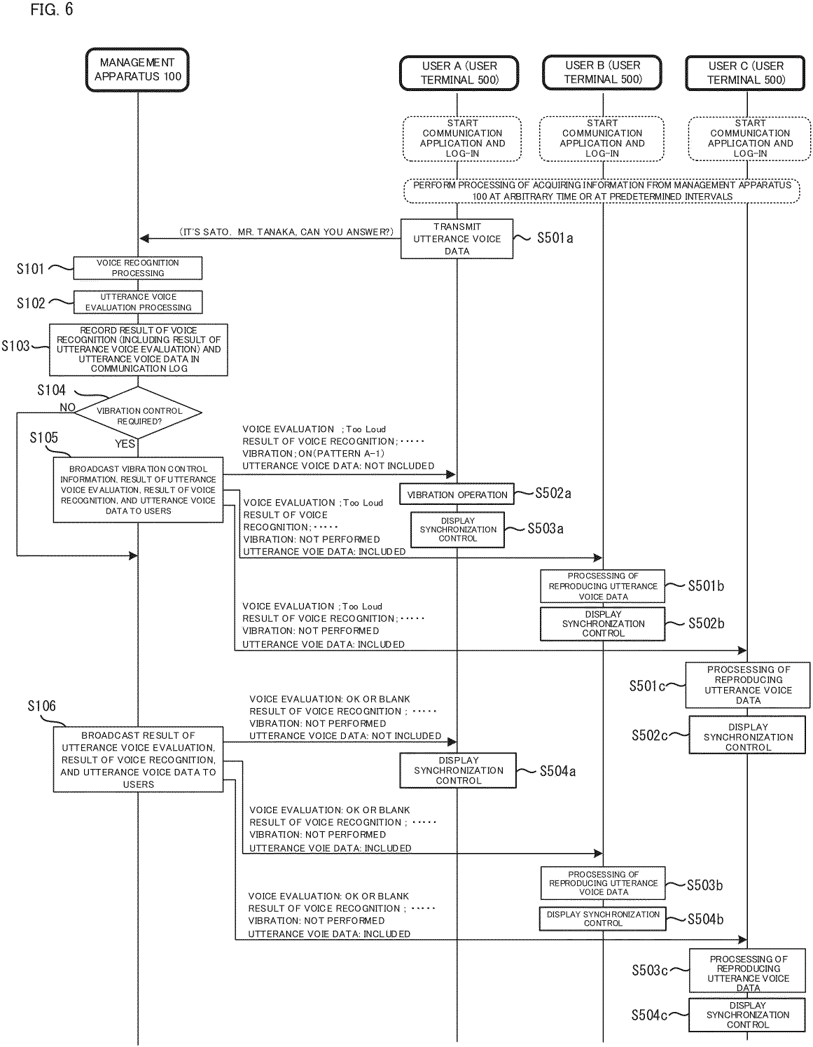

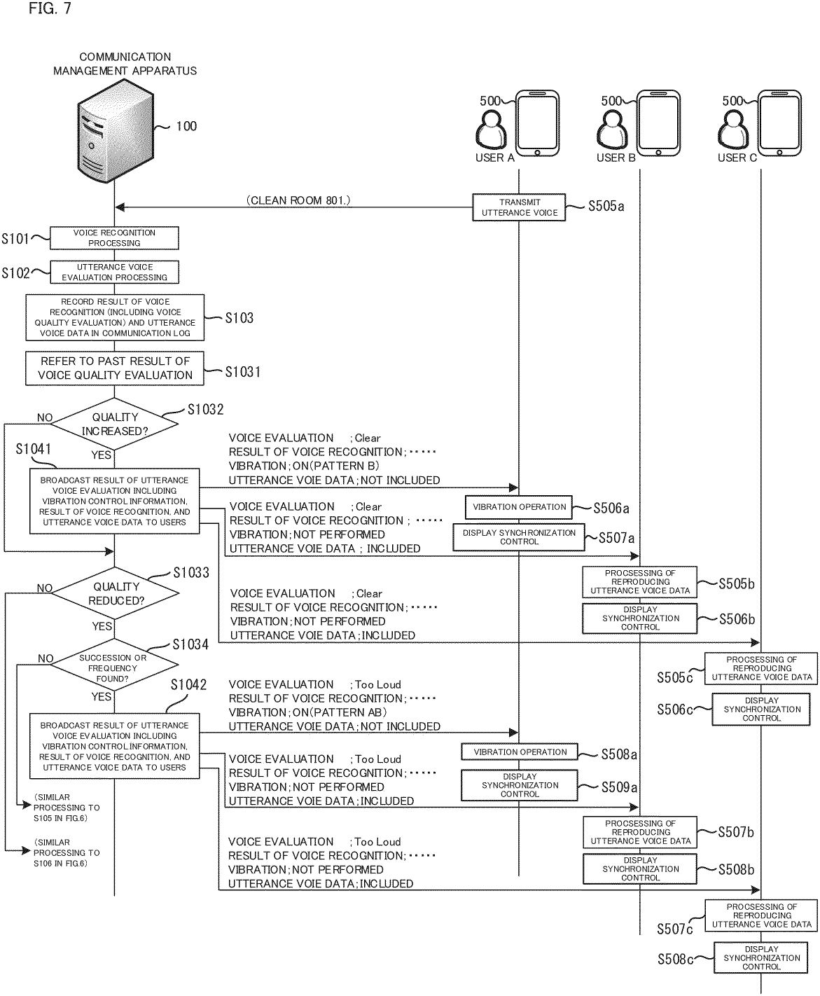

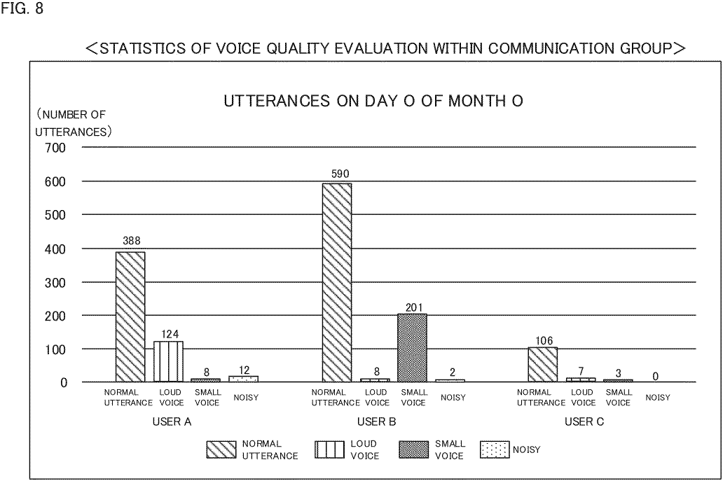

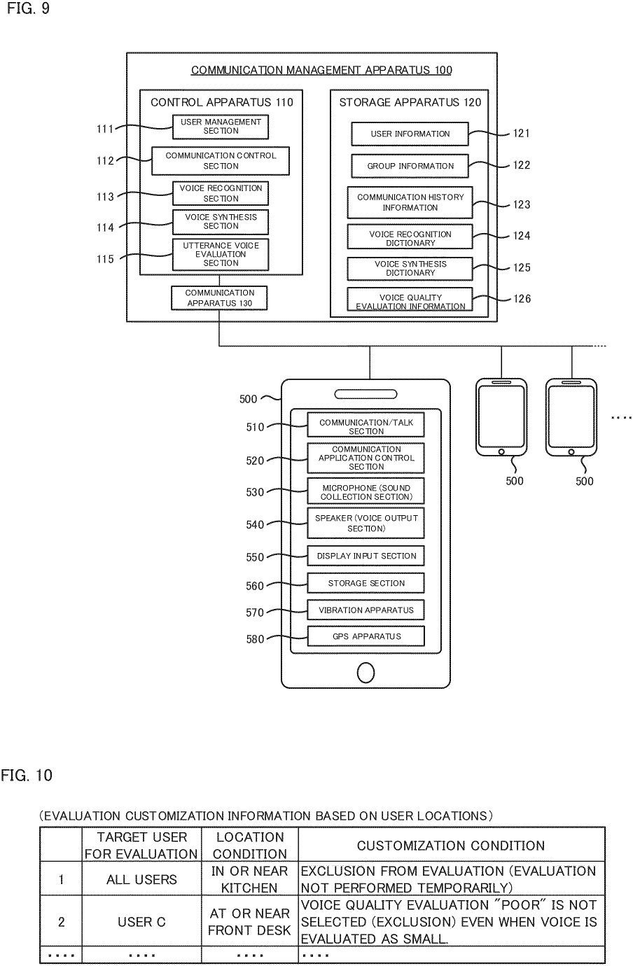

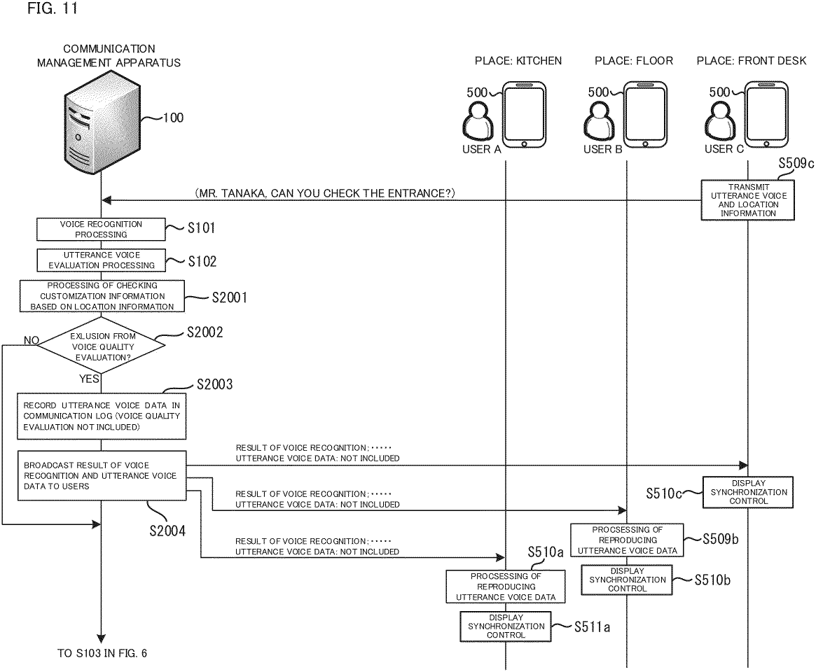

### BRIEF DESCRIPTION OF THE DRAWINGS

[FIG. 1] A diagram showing the configuration of a network of a communication system according to Embodiment 1.

[FIG. 2] A block diagram showing the configurations of a communication management apparatus and a user terminal according to Embodiment 1.

[FIG. 3] A diagram showing exemplary user information and exemplary group information according to Embodiment 1.

[FIG. 4] A diagram showing exemplary screens displayed on user terminals according to Embodiment 1.

[FIG. 5] Diagrams showing an exemplary voice waveform and exemplary voice quality evaluation information according to Embodiment 1.

[FIG. 6] A diagram showing a flow of processing performed in the communication system according to Embodiment 1.

[FIG. 7] A flow of processing illustrating exemplary vibration control performed in response to increased quality or reduced quality based on a voice quality evaluation history according to Embodiment 1.

[FIG. 8] A diagram showing an exemplary display of a statistical history of voice quality evaluation results from users within a communication group according to Embodiment 1.

[FIG. 9] A block diagram showing the configurations of a communication management apparatus and a user terminal according to Embodiment 2.

[FIG. 10] A diagram showing exemplary evaluation customization information based on user locations according to Embodiment 2.

[FIG. 11] A diagram showing a flow of processing performed in a communication system according to Embodiment 2.

### MODE FOR CARRYING OUT THE INVENTION

### Embodiment 1

FIGS. 1 to 8 are diagrams showing the configuration of a network of a communication system according to Embodiment 1. The communication system provides an information transmission assistance function with the use of voice and text such that a communication management apparatus (hereinafter referred to as a management apparatus) 100 plays a central role. An aspect of using the communication system for operation and management of facilities including accommodation facilities is described below, by way of example.

The management apparatus 100 is connected to user terminals (mobile communication terminals) 500 carried by users through wireless communication. The management apparatus 100 broadcasts utterance voice (speech voice) data received from one of the user terminals 500 to the other user terminals 500.

The user terminal 500 may be a multi-functional cellular phone such as a smartphone, or a portable terminal (mobile terminal) such as a Personal Digital Assistant (PDA) or a tablet terminal. The user terminal 500 has a communication function, a computing function, and an input function, and connects to the management apparatus 100 through wireless communication over the Internet Protocol (IP) network or Mobile Communication Network to perform data communication.

A communication group is set to define the range in which the voice of an utterance (speech) of one of the users can be broadcast to the user terminals 500 of the other users (or the range in which a communication history, later described, can be displayed in synchronization). Each of the user terminals 500 of the relevant users (field users) is registered in the communication group.

The communication system according to Embodiment 1 assists in information transmission for sharing of recognition, conveyance of intention and the like based on the premise that the plurality of users can perform hands-free interaction with each other. Specifically, the communication system according to Embodiment 1 evaluates ease of hearing of a user’s utterance voice and provides a function of sharing the result of evaluation within the communication group and a function of feeding the result of evaluation back to the user who spoke. This helps quality improvement of information transmission among the users.

When a user’s utterance voice is difficult to hear during one-to-one or one-to-many conversation, information transmission may not be performed smoothly. For example, the user may be asked to say it again or the information may be transmitted in a different meaning from the intended content. Asking the user to say it again may reduce the efficiency in information transmission with waste of time, thereby resulting in inefficiency involving delayed user actions. Transmitting the information in a different meaning may lead to errors in works or the need to perform works again.

When a user’s utterance voice causes trouble in hearing or is offensive, users who hear the voice may have an unpleasant feeling. For a communication environment, user’s utterance voices pleasant to the other users easily provide an environment which allows smooth information transmission among the users (for example, an environment in which the users can perform works smoothly).

In the communication group including many users, however, training each of the users on how to speak clearly or how to change annoying utterance voices is difficult in terms of effort, time, and human relationship. Accordingly, there is a need to provide an environment in which a user voluntarily recognizes his need to improve his utterance voice and easily takes action for such improvement.

The communication system provides an environment in which the quality of a user’s utterance voice is evaluated to encourage voluntary improvement by providing a function of sharing the result of evaluation of utterance voice quality of each user within the communication group. The communication system also provides a function of feeding the evaluated high or low quality of the user’s utterance voice back to the user to further help realize an environment in which the user easily takes action for quality improvement of his utterance voice.

The following description is made in an aspect in which the communication system has both the function of sharing the result of evaluation of each user’s utterance voice quality within the communication group and the function of feeding the evaluated high or low quality of the user’s utterance voice back to the user. Alternatively, the communication system may have only the function of sharing the result of evaluation of each user’s utterance voice quality within the communication group.

FIG. 2 is a block diagram showing the configurations of the management apparatus 100 and the user terminal 500.

The management apparatus 100 includes a control apparatus 110, a storage apparatus 120, and a communication apparatus 130. The communication apparatus 130 manages communication connection and controls data communication with the user terminals 500. The communication apparatus 130 controls broadcast to distribute utterance voice data from one of the users and text information representing the content of the utterance (text information provided through voice recognition processing on the utterance voice data) to the user terminals 500 at the same time.

The control apparatus 110 includes a user management section 111, a communication control section 112, a voice recognition section 113, a voice synthesis section 114, and an utterance voice evaluation section 115. The storage apparatus 120 includes user information 121, group information 122, communication history (communication log) information 123, a voice recognition dictionary 124, a voice synthesis dictionary 125, and voice quality evaluation information.

The voice synthesis section 114 and the voice synthesis dictionary 125 provide a voice synthesis function of receiving a character information input of text form on the user terminal 500 or a character information input of text form on an information input apparatus other than the user terminal 500 (for example, a mobile terminal or a desktop PC operated by a manager, an operator, or a supervisor), and converting the character information into voice data. However, the voice synthesis function in the communication system according to Embodiment 1 is an optional function. In other words, the communication system according to Embodiment 1 may not have the voice synthesis function. When the voice synthesis function is included, the communication control section 112 of the management apparatus 100 receives text information input on the user terminal 500, and the voice synthesis section 114 synthesizes voice data corresponding to the received text characters with the voice synthesis dictionary 125 to produce synthesized voice data. The synthesized voice data can be produced from any appropriate materials of voice data. The synthesized voice data and the received text information are broadcast to the other user terminals 500.

The user terminal 500 includes a communication/talk section 510, a communication application control section 520, a microphone 530, a speaker 540, a display input section 550 such as a touch panel, and a storage section 560. The speaker 540 is actually formed of earphones or headphones (wired or wireless). A vibration apparatus 570 is an apparatus for vibrating the user terminal 500.

FIG. 3 is a diagram showing examples of various types of information. User information 121 is registered information about users of the communication system. The user management section 111 controls a predetermined management screen to allow setting of a user ID, user name, attribute, and group on that screen. The user management section 111 manages a list of correspondences between a history of log-ins to the communication system on user terminals 500, the IDs of the users who logged in, and identification information of the user terminals 500 of those users (such as MAC address or individual identification information specific to each user terminal 500).

Group information 122 is group identification information representing defined communication groups. The communication management apparatus 100 controls transmission/reception and broadcast of information for each of the communication groups having respective communication group IDs to prevent mixed information across different communication groups. Each of the users in the user information 121 can be associated with the communication group registered in the group information 122.

The user management section 111 according to Embodiment 1 controls registration of each of the users and provides a function of setting a communication group to perform first control (broadcast of utterance voice data) and second control (broadcast of an agent utterance text and/or a text representing the result of recognition of a user’s utterance voice), as later described.

Depending on a specific facility in which the communication system according to Embodiment 1 is introduced, grouping can be used to perform facility management by classifying the facility into a plurality of divisions. In an example of an accommodation facility, bellpersons (porters), concierges, and housekeepers (cleaners) can be classified into different groups, and the communication environment can be established such that hotel room management is performed within each of those groups. In another viewpoint, communications may not be required for some tasks. For example, serving staff members and bellpersons (porters) do not need to directly communicate with each other, so that they can be classified into different groups. In addition, communications may not be required from geographical viewpoint. For example, when a branch office A and a branch office B are remotely located and do not need to frequently communicate with each other, they can be classified into different groups.

The communication control section 112 of the management apparatus 100 functions as control sections including a first control section and a second control section. The first control section controls broadcast of utterance voice data received from one user terminal 500 to the other user terminals 500. The second control section chronologically accumulates the result of utterance voice recognition from voice recognition processing on the received utterance voice data in the user-to-user communication history 123 and controls text delivery such that the communication history 123 is displayed in synchronization on all the user terminals 500 including the user terminal 500 of the user who spoke.

The function provided by the first control section is broadcast of utterance voice data. The utterance voice data mainly includes voice data representing a user’s voice. When the voice synthesis function is included as described above, the synthesized voice data produced artificially from the text information input on the user terminal 500 is also broadcast by the first control section.

The function provided by the second control section is broadcast of the text representing the result of recognition of the user’s utterance voice. All the voices input to the user terminals 500 and reproduced on the user terminals 500 are converted into texts which in turn are accumulated chronologically in the communication history 123 and displayed on the user terminals 500 in synchronization. The voice recognition section 113 performs voice recognition processing with the voice recognition dictionary 124 to output text data as the result of utterance voice recognition. The voice recognition processing can be performed by using any of known technologies.

The utterance voice evaluation section 115 performs predetermined voice quality evaluation processing on the received utterance voice of the user, that is, the utterance voice data to be broadcast to the other users, to produce the result of voice quality evaluation.

In Embodiment 1, the result of voice quality evaluation is accumulated in association with the result of recognition of the user’s utterance voice accumulated in the communication history 123. The second control section broadcasts the result of recognition of the user’s utterance voice and the associated result of voice quality evaluation together in text form.

The communication control section 112 (for example, the second control section) performs processing of providing feedback for the user who spoke, that is, the person whose voice data was subjected to the voice quality evaluation processing. The feedback processing is later described in detail.

The communication history information 123 is log information including contents of utterances of the users, together with time information, accumulated chronologically on a text basis. Voice data corresponding to each of the texts can be stored as a voice file in a predetermined storage region, and for example, the position of the stored voice file is recorded in the communication history 123. The communication history information 123 is created and accumulated for each communication group. The result of voice quality evaluation can be accumulated in the communication history information 123 or accumulated in an individual storage region in association with the utterance content.

FIG. 4 is a diagram showing an example of the communication history 123 displayed on the user terminals 500. Each of the user terminals 500 receives the communication history 123 from the management apparatus 100 in real time or at a predetermined time, and the display thereof is synchronized among users. The users can chronologically refer to the communication log.

As in the example of FIG. 4, each user terminal 500 chronologically displays the utterance content of the user of that terminal 500 and the utterance contents of the other users in the display field D to share the communication history 123 accumulated in the management apparatus 100 as log information. In a display field D, a user’s own utterance text may be accompanied by a microphone mark H, and the users other than that user who spoke may be shown by a speaker mark M instead of the microphone mark H in the display field D.

As shown in FIG. 4, voice quality evaluation information (voice quality evaluation comment) C is displayed adjacent to the field for displaying the text of utterance in the display field D.

Next, the voice quality evaluation processing on a user’s utterance voice is described. FIG. 5 shows an exemplary voice waveform and exemplary voice quality evaluation information.

The exemplary voice waveform shown in FIG. 5 has a vertical axis representing amplitude and a horizontal axis representing time. An example of an utterance difficult to hear is “an utterance of loud voice.” Such a loud voice of a user may exceed the upper limit of a range of sounds collectable by a microphone (upper limit of voice input) and result in a muffled voice as a whole utterance(speech) which the other users generally have trouble in hearing. Specifically, as shown in the example of FIG. 5, the loud voice of the user produces series of cycles of the amplitude each appearing as a filled-in area in which it is difficult to hear characteristic consonant and vowel sounds constituting the utterance. Depending on the performance of microphone, part of the wave above the upper limit of voice input is cut uniformly, so that the characteristic waveform representing consonant and vowel sounds is not detected properly. In addition to the case of the user’s loud voice, emphasized low-pitched sound due to a short distance between the microphone and the user’s mouth causes trouble in hearing for the same reason as that in the loud voice.

A small voice may also cause trouble in hearing. In contrast to the loud voice, the small voice produces a waveform having extremely lower amplitude levels in which it is difficult to hear characteristic consonant and vowel sounds constituting the utterance. In addition, ambient noise may cause trouble in hearing the content of the utterance.

In Embodiment 1, the voice quality evaluation information shown in FIG. 5 is preset as a metric for quantitatively evaluating the quality of a user’s utterance voice in terms of difficulty in hearing or trouble in hearing, in other words, in terms of ease of listening or ease of hearing. The voice quality evaluation information may be set in any appropriate manner. For example, a plurality of sample voices are subjectively evaluated by the Mean Opinion Score, and the physical characteristics of the voices such as the amplitude are extracted or estimated to produce ranked objective quality evaluations. The physical characteristics of the produced objective quality evaluations can be matched with the physical characteristics of the user’s utterance voice data to evaluate the voice quality of the utterance voice data.

In the example of FIG. 5, the voice evaluation has three ranks including “excellent,” “good,” and “poor,” each of which is assigned one or more evaluation setting values. The evaluation setting value assigned to each of the voice evaluation ranks can include an evaluation criterion, for example, based on the relationship between the amplitude waveform of received utterance voice data and the upper limit of voice input. Each of the voice evaluation ranks is also assigned one or more voice quality evaluation comments. By way of example, the voice evaluation rank “poor” may be assigned three evaluation setting values, each of which may be assigned a different voice quality evaluation comment. The settings of the voice evaluation ranks, the evaluation setting value and the voice quality evaluation comment for each rank are performed in any appropriate manner.

For example, the voice quality evaluation comment can be specified such that "Clear" is assigned to the "excellent" voice evaluation rank, "OK" is assigned to the "good" voice evaluation rank, and "Too Loud," "Small Voice," and "Too Noisy" are assigned to the "poor" voice evaluation rank.

The communication control section 112 (second control section) broadcasts the voice quality evaluation comment (result of voice quality evaluation) together with the result of voice recognition in text form to share the result of voice quality evaluation among the users within the communication group.

The communication control section 112 also provides the feedback function for the user whose utterance voice was evaluated. In the example of FIG. 5, one or more vibration control values are set as feedback control information for each of the voice evaluation ranks. The vibration control value is a control command (including a vibration pattern) for the vibration apparatus 570 of the user terminal 500. The vibration control value is output to the user terminal 500 of the target user for evaluation. The communication control section 112 (second control section) delivers the result of voice recognition, the voice quality evaluation comment, and the vibration control value to the user terminal 500 of the target user for evaluation, and delivers the result of voice recognition and the voice quality evaluation comment to the user terminals 500 of the other users. The voice quality evaluation comment is stored as the result of voice quality evaluation in the communication history 123.

When the user terminal 500 receives the vibration control value during control for displaying the received text information, the user terminal 500 actuates the vibration apparatus 570 to vibrate the user terminal 500. This can feed the result of voice quality evaluation back to the user who essentially uses the user terminal 500 in a hands-free manner.

It should be noted that the vibration control values can be provided in a plurality of patterns and combined as appropriate for the respective evaluations. For example, a vibration control value A-1 to be selected when the voice is evaluated as being loud and a vibration control value A-2 to be selected when the voice is evaluated as being small are set in different vibration patterns (vibration rhythm patterns).

The vibration control value may be provided for the user terminal 500 when a predetermined condition is satisfied. For example, the predetermined condition is specified such that the vibration control value is output only when the voice evaluation rank is “poor” but not output when the voice evaluation rank is “excellent” and “good,” thereby allowing the user to know that the voice quality has not been reduced.

FIG. 6 is a diagram showing a flow of processing performed in the communication system according to Embodiment 1.

Each of the users starts the communication application control section 520 on his user terminal 500, and the communication application control section 520 performs processing for connection to the management apparatus 100. Each user enters his user ID and password on a predetermined log-in screen to log in to the management apparatus 100. The log-in authentication processing is performed by the user management section 111. After the log-in, each user terminal 500 performs processing of acquiring information from the management apparatus 100 at an arbitrary time or at predetermined time intervals.

When a user A speaks, the communication application control section 520 collects the voice of that utterance and transmits the utterance voice data to the management apparatus 100 (S501a). The voice recognition section 113 of the management apparatus 100 performs voice recognition processing on the received utterance voice data (S101) and outputs the result of voice recognition of the utterance content. Simultaneously with or independently of the voice recognition processing, the utterance voice evaluation section 115 performs voice quality evaluation processing on the received utterance voice data based on the voice quality evaluation information and outputs the result of voice quality evaluation (S102). The communication control section 112 stores the result of voice recognition and the result of voice quality evaluation in the communication history 123 and stores the utterance voice data in the storage apparatus 120 (S103).

The communication control section 112 determines whether or not the vibration control value should be transmitted to the user terminal 500 of the target user for evaluation based on the result of voice quality evaluation output from the utterance voice quality evaluation section 115 (S104). When it is determined that the vibration control value should be transmitted to the user terminal 500 of the target user for evaluation (YES at S104), the communication control section 112 transmits the vibration control value to the user terminal 500 of the target user A for evaluation together with the result of voice recognition including the result of voice quality evaluation for display synchronization (S105). The communication control section 112 also broadcasts the utterance voice data of the user A and delivers the text of the result of voice recognition including the result of voice quality evaluation for display synchronization to each of the user terminals 500 of the users other than the user A who spoke.

First, the vibration apparatus 570 of the user terminal 500 of the user A performs vibration operation based on the received vibration control value (S502a). The communication application control section 520 displays the received utterance content of text form and the result of voice quality evaluation in the display field D (S503a).

Each of the user terminals 500 of the users other than the user A performs automatic reproduction processing on the received utterance voice data to output the reproduced utterance voice (S501b, S501c), and displays the utterance content of text form corresponding to the output reproduced utterance voice and the result of voice quality evaluation in the display field D (S502b, S502c).

When it is determined that no vibration control value should be transmitted to the user terminal 500 of the target user for evaluation (NO at S104), the communication control section 112 transmits no vibration control value to the user A of the target user for evaluation and transmits the utterance content (in text form) of the user A stored in the communication history 123 and the result of voice quality evaluation to all the user terminals 500 within the communication group including the user terminal 500 of the user A for display synchronization (S106). The communication control section 112 broadcasts the utterance voice data of the user A to the user terminals 500 of the users other than the user A who spoke.

The user terminal 500 of the user A receives no vibration control value in this case, so that the communication application control section 520 displays the received utterance content of text form and the result of voice quality evaluation in the display field D (S504a). Each of the user terminals 500 of the users other than the user A performs automatic reproduction processing on the utterance voice data to output the reproduced utterance voice (S503b, S503c), and displays the utterance content of text form corresponding to the output reproduced utterance voice and the result of voice quality evaluation in the display field D (S504b, S504c), similarly to the steps described above.

The communication control section 112 may be configured to perform the delivery processing including the broadcast of the utterance voice data and the delivery of the text independently of the transmission of the vibration control value to the user terminal 500 of the target user for evaluation. Specifically, the delivery processing can be performed through multicast data transfer to the users belonging to the communication group, whereas the transmission of the vibration control value can be performed through unicast data transfer to the target user for evaluation. The delivery processing in the multicast data transfer and the transmission in the unicast data transfer can be performed in parallel to ensure smooth information transmission within the communication group separately from the feedback to the target user for evaluation.

FIG. 7 shows a flow of processing illustrating an example of the vibration control performed in the communication system in view of the voice quality evaluation history according to Embodiment 1. It should be noted that the same processing steps as those in FIG. 6 are designated with the same reference numerals and their description is omitted.

The utterance voice evaluation section 115 (or the communication control section 112) refers to the past result of voice quality evaluation of the target user for evaluation in the voice quality evaluation processing on the received utterance voice data (S1031), selects one of the vibration control values in different patterns based on the comparison between the past evaluation result and the current evaluation result, and transmits the selected vibration control value to the user terminal 500 of the target user for evaluation.

When the current result of voice quality evaluation is “excellent” and the previous result of voice quality evaluation is “poor,” the utterance voice evaluation section 115 determines that the voice quality has been increased (YES at S1032), selects and transmits and the vibration control value of a vibration pattern B to the user terminal 500 of the target user for evaluation (S1041). The vibration pattern B is different from a vibration pattern A to be selected when the result of voice quality evaluation is determined as “poor.” The similar operations are performed when the current result of voice quality evaluation is “good” and the previous result of voice quality evaluation is “poor,” and when the current result of voice quality evaluation is “excellent” and the previous result of voice quality evaluation is “good.”

In other words, when the result of voice quality evaluation (voice evaluation rank) is improved relative to the result immediately before (the previous result), the vibration control value is output to provide the feedback indicating the increased voice quality for the user terminal 500, which allows the user to know the improved utterance voice quality intuitively.

The user terminal 500 of the target user A for evaluation controls operations of the vibration apparatus 570 based on the received vibration control value (S506a). The communication application control section 520 displays the received utterance content of text form and the result of voice quality evaluation in the display field D (S507a).

Each of the user terminals 500 of the users other than the user A performs automatic reproduction processing on the received utterance voice data to output the reproduced utterance voice (S505b, S505c), and displays the utterance content of text form corresponding to the output reproduced utterance voice and the result of voice quality evaluation in the display field D (S506b, S506c).

When the current result of voice quality evaluation is “poor” or when the current result of voice quality evaluation is “excellent” after the previous result of voice quality evaluation “excellent” (or when the current result of voice quality evaluation is “good” after the previous result of voice quality evaluation “good”), the control proceeds to step S1033. At step S1033, when the current result of voice quality evaluation is “excellent” after the previous result of voice quality evaluation “excellent” (or when the current result of voice quality evaluation is “good” after the previous result of voice quality evaluation “good”), similar processing to that at step S106 in FIG. 6 is performed.

Alternatively, when the current result of voice quality evaluation is “poor,” it is determined that the voice quality has been reduced (YES at S1033), the previous result of voice quality evaluation is referred to. Then, the succession of quality reductions or the frequency (number of times) of quality reductions is determined (S1034).

At step S1034, when the previous result of voice quality evaluation is “excellent,” it is determined, for example, that the succession of quality reductions or the frequency (number of times) of quality reductions is not found (NO at S1034), and similar processing to that at step S105 in FIG. 6 is performed. Alternatively, when the previous result of voice quality evaluation is also “poor,” it is determined that the succession of quality reductions or the frequency (number of times) of quality reductions is found (YES at S1034), and the control proceeds to step S1042. At step S1042, unlike the vibration control value transmitted at step 105 in FIG. 6, the vibration control value of a vibration pattern AB indicating a long succession of quality reductions or a high frequency of quality reductions is selected and transmitted to the user terminal 500 of the user A.

The user terminal 500 of the target user A for evaluation controls operation of the vibration apparatus 570 based on the received vibration control value (vibration pattern AB) (S508a). The communication application control section 520 displays the received utterance content of text form and the result of voice quality evaluation in the display field D (S509a).

Each of the user terminals 500 of the users other than the user A performs automatic reproduction processing on the received utterance voice data to output the reproduced utterance voice (S507b, S507c), and displays the utterance content of text form corresponding to the output reproduced utterance voice and the result of voice quality evaluation in the display field D (S508b, S508c).

As described above, the vibration apparatus 570 is operated in response to the increased voice quality or the reduced voice quality to notify the user. The feedback about the voice quality can be provided for the user terminal 500 to allow the user to know the status of his utterance voice quality intuitively, which encourages the user to consciously and voluntarily improve his voice quality.

For the reduced voice quality, the succession of voice quality reductions may be taken into account. For example, when the current result of voice quality evaluation is “poor,” the past evaluation results can be tracked back over a predetermined number of evaluations to check the succession of the results of voice quality evaluation “poor,” and the vibration control value of a different vibration pattern can be used depending on the succession.

By way of example, when the previous result of voice quality evaluation is “poor,” this means two consecutive quality reductions, and the vibration control value of a vibration pattern “beep, beep” is provided for the user terminal 500. When the result of voice quality evaluation before the previous result is also “poor,” this means three consecutive quality reductions, and the vibration control of a vibration pattern “beep, beep, beep,” which is different from the pattern for two consecutive quality reductions, is provided for the user terminal 500.

In addition to the succession of the results of voice quality evaluation “poor,” the number of results of voice quality evaluation “poor” during a predetermined period can be counted, and control can be performed depending on the frequency (number of times) of quality reductions. For example, control may be performed to use the vibration control value of a different vibration pattern depending on the number of results of voice quality evaluation “poor” during the predetermined period.

When the result of voice quality evaluation “poor” has been repeatedly output in succession, or when the result of voice quality evaluation “poor” has been repeatedly output during a predetermined period, a function of notifying a responsible person and/or a manager of the communication group can be performed. For example, the user terminal 500 of the responsible person of the communication group can be notified of a particular user whose voice quality has been deteriorated significantly or can be provided with the vibration control value assigned to that notification. The particular user can be guided by the responsible person to address the deteriorated voice quality.

For the control related to the succession or frequency of the results of voice quality evaluation “poor,” when the result of voice quality evaluation is improved to “good” or “excellent” during the chronological evaluation history, the counter can be reset at the point of improvement. The communication control section 112 can perform control at a predetermine time to restart, from zero, the count of consecutive results of voice quality evaluation “poor” or the count of results of voice quality evaluation “poor” during the predetermined period.

FIG. 8 is a diagram showing an exemplary display of a statistical history of voice quality evaluation results of users within the communication group.

The utterance voice evaluation section 115 can use the results of voice quality evaluation for each of the users accumulated in association with the communication history 123 to produce and provide voice quality evaluation statistical information within the communication group as shown in FIG. 8 for the respective user terminals 500. For example, the utterance voice evaluation section 115 can aggregate and rank the results of voice quality evaluation of the respective users in arbitrary periods such as time zones, days, and months, to produce the voice quality evaluation statistical information in tabular form.

In the example of FIG. 8, "normal utterance" corresponds to the result of voice quality evaluation of the voice quality rank "excellent" or "good." "Loud voice" corresponds to the result of voice quality evaluation "Too Loud" in the voice quality rank "poor." "Small voice" corresponds to the result of voice quality evaluation "Small Voice" in the voice quality rank "poor." "Noise" corresponds to the result of voice quality evaluation "Too Noisy" in the voice quality rank "poor."

Thus, each user and the responsible person and/or the manager of the communication group can view the utterance voice quality evaluation history of an arbitrary period specified by year, month, day, and time, or of a particular day or time zone to allow the user to review his own utterance or the other user’s utterance. This can further encourage the user to consciously and voluntarily improve his voice quality.

### Embodiment 2

FIGS. 9 to 11 are diagrams showing the configuration of a network of a communication system according to Embodiment 2. The communication system according to Embodiment 2 differs from Embodiment 1 described above in that voice quality evaluation is customized in accordance with the location of a user (user terminal 500). It should be noted that the same components as those in Embodiment 1 are designated with the same reference numerals and their description is omitted.

FIG. 9 is a block diagram showing the configurations of the communication management apparatus 100 and the user terminal 500 according to Embodiment 2. Unlike FIG. 2 illustrating Embodiment 1, the user terminal 500 includes a GPS apparatus (location information acquisition apparatus) 580. The GPS apparatus 580 is existing location information acquisition means.

Embodiment 2 provides a function of acquiring the information about the location of a user who spoke as well as utterance voice data from the user terminal 500 of the user, and depending on the user location, excluding the user from targets for voice quality evaluation processing, or performing more severe or less severe voice quality evaluation.

FIG. 10 is a diagram showing exemplary evaluation customization information based on user locations. As shown in FIG. 10, the evaluation customization information is specified to include target users for evaluation, location conditions, and customization conditions. For example, when a user is situated at a place in or near a kitchen where much noise is expected to be produced at all times, the results of voice quality evaluation “loud voice,” “small voice, ” and “much noise” are not attributable to the user but to the environment. Accordingly, as shown in FIG. 10, when it is determined that any one of all the users spoke in or near the kitchen specified as an evaluation exclusion place, control can be performed such that the user is temporarily excluded from the targets for voice quality evaluation.

There are some places such as the front desk and its surroundings of an accommodation facility where any user needs to speak in a small voice with attention to the surroundings. In this case, it is more undesirable to allow a user to speak in “a loud voice” than to evaluate the user’s voice as “small” meaning that the voice quality is low. Thus, when it is determined that the user spoke at or near the front desk specified as an evaluation exclusion place, the user can be excluded temporarily from the targets for voice quality evaluation as described above, or the utterance voice evaluation of the user is not determined as “poor” even when the user’s voice is evaluated as being small as shown in FIG. 10.

In the latter case, the result of voice quality evaluation performed on the utterance voice data can be subjected to correction processing of producing a less severe result of voice quality evaluation based on the user location information. For example, the result of voice quality evaluation “poor” can be changed into the result of voice quality evaluation “good,” and the changed result of voice quality evaluation can be provided for and shared among the users within the communication group similarly to Embodiment 1.

The customization which includes producing a more severe result of voice quality evaluation can also be performed. At or near the front desk of an accommodation facility, a “smaller voice” than usual may be given a higher evaluation and a “louder voice” may be given a lower evaluation with attention to the surroundings. Thus, when the result of voice quality evaluation performed on the utterance voice data is “good,” correction processing is performed to perform more severe voice quality evaluation based on the user location information. For example, when the result of voice quality evaluation of the utterance voice is “good” at or near the front desk, the correction processing can be performed to change the result into the result of voice quality evaluation “poor” in view of the user location at or near the front desk. Similarly to Embodiment 1, the changed result of voice quality evaluation can be provided for and shared among the users within the communication group. Feedback processing can be performed similarly.

As described above, the voice quality evaluation is not performed or the voice quality evaluation criterion is changed in accordance with the place where the user spoke, which can provide the voice quality evaluation environment appropriate for the environment where the user speaks. This can achieve appropriate evaluation of the user utterance voice with different attentions to different locations. For example, a speaker may make an explanation of the utterance environment related to his current place by saying “Currently I’m near the front desk and speak in a lower tone with attention to the surroundings.” In this case, this utterance is not given a low voice quality evaluation, so that the communication group can share the recognition that it is better not to speak in a loud voice at or near the front desk. As a result, this can help voice quality improvement in view of the different utterance locations.

As shown in FIG. 10, a single user, a plurality of users, or all the users can be specified as target users for evaluation depending on the place set in the location condition. For example, users may have previously assigned tasks such as a front desk clerk and a room clerk. In this case, the locations where those users may speak can be previously expected, and when one of the users speaks at such an expected location, the customization evaluation can be performed. When a user speaks somewhere other than the place set in the location condition and the user is not one of the target users for evaluation, the customization evaluation is not performed, so that unbiased voice quality evaluation can be performed.

FIG. 11 is a diagram showing a flow of processing performed in the communication system according to Embodiment 2. It should be noted that the same processing steps as those in FIG. 6 are designated with the same reference numerals and their description is omitted.

When the user C speaks, the communication application control section 520 collects the voice of that utterance, acquires location information from the GPS apparatus 580, and transmits the utterance voice data and the location information to the management apparatus (S509a). The voice recognition section 113 of the management apparatus 100 performs voice recognition processing on the received utterance voice data (S101) and outputs the result of voice recognition of the utterance content. Simultaneously with or independently of the voice recognition processing, the utterance voice evaluation section 115 performs voice quality evaluation processing on the received utterance voice data and outputs the result of voice quality evaluation based on the voice quality evaluation information (S102).

The utterance voice evaluation section 115 refers to the evaluation customization information based on user locations using the location information received from the user terminal 600 to extract any of the customization information that satisfies the conditions of the target user and location (S2001). The location condition is previously specified, for example, by information indicating a range of locations at and near the front desk.

When any of the customization conditions is extracted, the utterance voice evaluation section 115 performs the processing of exclusion from the voice quality evaluation in accordance with that customization condition or the processing of correcting the result of voice quality evaluation at step S2001. The example of FIG. 11 shows an aspect in which it is determined whether or not the customization condition specifies the exclusion from the voice quality evaluation. When the exclusion from the voice quality evaluation is determined at step S2002, the control proceeds to step S2003 and the communication control section 112 stores the result of voice recognition in the communication history 123 and does not store the result of voice quality evaluation output at step S102.

The communication control section 112 transmits the result of voice recognition to the user terminal 500 of the user C, and the communication application control section 520 displays the received utterance content of text form in the display field D (S510c).

Each of the user terminals 500 of the users other than the user C performs automatic reproduction processing on the received utterance voice data to output the reproduced utterance voice (S510a, S509b), and displays the utterance content of text form corresponding to the output reproduced utterance voice and the result of voice quality evaluation in the display field D (S511a, S510b).

While the vibration control value is used herein for the feedback control information, the present invention is not limited thereto, and various sounds may be used to give notice to the user (for example, sounds from alarm clocks (bleep) or buzzer sounds). The control value may be implemented by varying sound volumes or varying numbers of constant tones. The result of quality evaluation may be output in the form of a synthesized sound (“loud voice” or “small voice”).

Various embodiments of the present invention have been described. The functions of the communication management apparatus 100 and the use terminal 500 can be implemented by a program. A computer program previously provided for implementing the functions can be stored on an auxiliary storage apparatus, the program stored on the auxiliary storage apparatus can be read by a control section such as a CPU to a main storage apparatus, and the program read to the main storage apparatus can be executed by the control section to perform the functions.

The program may be recorded on a computer readable recording medium and provided for the computer. Examples of the computer readable recording medium include optical disks such as a CD-ROM, phase-change optical disks such as a DVD-ROM, magneto-optical disks such as a Magnet-Optical (MO) disk and Mini Disk (MD), magnetic disks such as a Floppy Disk® and removable hard disk, and memory cards such as a Compact Flash®, smart media, SD memory card, and memory stick. Hardware apparatuses such as an integrated circuit (such as an IC chip) designed and configured specifically for the purpose of the present invention are included in the recording medium.

While various embodiments of the present invention have been described above, these embodiments are only illustrative and are not intended to limit the scope of the present invention. These novel embodiments can be implemented in other forms, and various omissions, substitutions, and modifications can be made thereto without departing from the spirit or scope of the present invention. These embodiment and their variations are encompassed within the spirit or scope of the present invention and within the invention set forth in the claims and the equivalents thereof.

### Description of the Reference Numerals

100 COMMUNICATION MANAGEMENT APPARATUS
110 CONTROL APPARATUS
111 USER MANAGEMENT SECTION
112 COMMUNICATION CONTROL SECTION (FIRST CONTROL SECTION, SECOND CONTROL SECTION)
113 VOICE RECOGNITION SECTION
114 VOICE SYNTHESIS SECTION
115 UTTERANCE VOICE EVALUATION SECTION
120 STORAGE APPARATUS
121 USER INFORMATION
122 GROUP INFORMATION
123 COMMUNICATION HISTORY INFORMATION
124 VOICE RECOGNITION DICTIONARY
125 VOICE SYNTHESIS DICTIONARY
126 VOICE QUALITY EVALUATION INFORMATION
130 COMMUNICATION APPARATUS
500 USER TERMINAL (MOBILE COMMUNICATION TERMINAL)
510 COMMUNICATION/TALK SECTION
520 COMMUNICATION APPLICATION CONTROL SECTION
530 MICROPHONE (SOUND COLLECTION SECTION)
540 SPEAKER (VOICE OUTPUT SECTION)
550 DISPLAY INPUT SECTION
560 STORAGE SECTION
570 VIBRATION APPARATUS
580 GPS APPARATUS
D DISPLAY FIELD

1. A communication system in which a plurality of users carry their respective mobile communication terminals and a voice of an utterance of one of the users input to his mobile communication terminal is broadcast to the mobile communication terminals of the other users, comprising:
a communication control section having a first control section configured to broadcast utterance voice data received from one of the mobile communication terminals to the other mobile communication terminals and a second control section configured to chronologically accumulate a result of utterance voice recognition from voice recognition processing on the received utterance voice data as a user-to-user communication history and to control text delivery such that the communication history is displayed on the mobile communication terminals in synchronization; and
a utterance voice evaluation section configured to perform voice quality evaluation processing on the received utterance voice data and to output a result of voice quality evaluation,
wherein the communication control section is configured to control text delivery such that the result of voice recognition based on the utterance voice and the result of voice quality evaluation are displayed on the user terminals.

2. The communication system according to claim 1, wherein the communication control section is configured to transmit, in conjunction with the text delivery control of the result of voice quality evaluation, feedback control information associated with the result of voice quality evaluation to the user terminal of the user who spoke, the utterance voice of the user having been subjected to the voice quality evaluation processing.

3. The communication system according to claim 2, wherein the feedback control information includes vibration.

4. The communication system according to claim 2 , wherein the result of voice quality evaluation comprises results of voice quality evaluation chronologically accumulated in association with the communication history for each of the users, and
the communication control section is configured to determine whether a quality of a current one of the results of voice quality evaluation is higher than a quality of a previous one of the results of voice quality evaluation or a quality of a current one of the results of voice quality evaluation is lower than a quality of a previous one of the results of voice quality evaluation, to select different feedback control information when the quality is higher and when the quality is lower, and to transmit the selected feedback control information to the user terminal of the user who spoke.

5. The communication system according to claim 2 , wherein the result of voice quality evaluation comprises results of voice quality evaluation chronologically accumulated in association with the communication history for each of the users, and
the communication control section is configured to select, when one of the results of voice quality evaluation has been repeatedly output at least a predetermined number of times in succession until and including a current one of the results of voice quality evaluation, different feedback control information according to the repeated number of times and to transmit the selected feedback control information to the user terminal of the user who spoke.

6. The communication system according to claim 2 , wherein the result of voice quality evaluation comprises results of voice quality evaluation chronologically accumulated in association with the communication history for each of the users, and
the communication control section is configured to count one of the results of voice quality evaluation provided during a specific past period, the one of the results being identical to a current one of the results of voice quality evaluation, to select different feedback control information according to the count of the identical results of evaluation, and to transmit the selected feedback control information to the user terminal of the user who spoke.

7. The communication system according to claim 1 ,wherein the result of voice quality evaluation comprises results of voice quality evaluation chronologically accumulated in association with the communication history for each of the users, and
the utterance voice evaluation section is configured to produce voice quality evaluation statistical information for each of the users within a communication group to be provided for each of the user terminals.

8. The communication system according to claim 1, wherein the communication control section is configured to receive, from the user terminal of the user who spoke, the utterance voice data and location information acquired on the user terminal, and
the utterance voice evaluation section is configured to determine whether or not a place where the user spoke is one of preset places, and when it is determined that the place where the user spoke is one of the preset places, to perform exclusion processing of performing no voice quality evaluation processing on the received utterance voice data or outputting no voice quality evaluation result.

9. The communication system according to claim 1, wherein the communication control section is configured to receive, from the user terminal of the user who spoke, the utterance voice data and location information acquired on the user terminal, and
the utterance voice evaluation section is configured to determine whether or not a place where the user spoke is one of preset places, and when it is determined that the place where the user spoke is one of the preset places, to perform correction processing of correcting the result of voice quality evaluation on the received utterance voice data.

10. A non-transitory computer-readable medium including a computer executable program comprising instructions executable by a management apparatus, a plurality of users carrying their respective mobile communication terminals, and a voice of an utterance of one of the users input to his mobile communication terminal being broadcast to the mobile communication terminals of the other users through the management apparatus, wherein the instructions, when executed by the management apparatus, cause the management apparatus to provide:
a first function of broadcasting utterance voice data received from one of the mobile communication terminals to the other mobile communication terminals;
a second function of chronologically accumulating a result of utterance voice recognition from voice recognition processing on the received utterance voice data as a user-to-user communication history and controlling text delivery such that the communication history is displayed on the mobile communication terminals in synchronization; and
a third function of performing voice quality evaluation processing on the received utterance voice data and outputting a result of voice quality evaluation,
wherein the second function includes controlling text delivery such that the result of voice recognition based on the utterance voice and the result of voice quality evaluation are displayed on the user terminals.

11. The communication system according to claim 3, wherein the result of voice quality evaluation comprises results of voice quality evaluation chronologically accumulated in association with the communication history for each of the users, and
the communication control section is configured to determine whether a quality of a current one of the results of voice quality evaluation is higher than a quality of a previous one of the results of voice quality evaluation or a quality of a current one of the results of voice quality evaluation is lower than a quality of a previous one of the results of voice quality evaluation, to select different feedback control information when the quality is higher and when the quality is lower, and to transmit the selected feedback control information to the user terminal of the user who spoke.

12. The communication system according to claim 3, wherein the result of voice quality evaluation comprises results of voice quality evaluation chronologically accumulated in association with the communication history for each of the users, and
the communication control section is configured to select, when one of the results of voice quality evaluation has been repeatedly output at least a predetermined number of times in succession until and including a current one of the results of voice quality evaluation, different feedback control information according to the repeated number of times and to transmit the selected feedback control information to the user terminal of the user who spoke.

13. The communication system according to claim 3, wherein the result of voice quality evaluation comprises results of voice quality evaluation chronologically accumulated in association with the communication history for each of the users, and
the communication control section is configured to count one of the results of voice quality evaluation provided during a specific past period, the one of the results being identical to a current one of the results of voice quality evaluation, to select different feedback control information according to the count of the identical results of evaluation, and to transmit the selected feedback control information to the user terminal of the user who spoke.
